(19) United States
(12) Patent Application Publication
(10) Pub. No.: US 2009/0067816 A1
(43) Pub. Date: Mar. 12, 2009

(54) Data playing system and method of the same

(75) Inventors: Chen Tung-Liang, Taichung (TW); Hsu Chih-Hung, Changhua County (TW); Lin Chun-Cheng, Taichung County (TW)

Correspondence Address: BACON & THOMAS, PLLC, 625 SLATERS LANE, FOURTH FLOOR, ALEXANDRIA, VA, 22314-1176, US

(73) Assignee: CHUNGHWA WIDEBAND BEST NETWORK CO., LTD., Taipei County (TW)

(21) Appl. No.: 11/898,098

(22) Filed: Sep. 10, 2007

(51) Int. Cl. H04N 7/26

(52) U.S. Cl. 386/124

(57) ABSTRACT

A data playing system for a video platform and a method of the same are provided. The data playing system for a video platform includes: a rear end information generating unit having an operating interface to provide, edit and generate an announced data; a signal frequency-dividing unit for extracting at least one video signal containing video data therein and the announced data of the rear end information generating unit, and for loading the announced data of the rear end information generating unit into the video signal; and a user end outputting unit for extracting and playing the video signal to represent the announced data of the rear end information generating unit and the video data.

### BACKGROUND OF THE INVENTION

1. Field of the Invention

The present invention relates to a data playing system and a method of the same, and in particular to a data playing system and a method of the same that can be applied to a video platform.

2. Description of Prior Art

Conventional video platform (or referred to as television platform) only plays video data (i.e. television programs). For example, Taiwan Patent No. 1270296 discloses a fast displaying device for a digital television program schedule, which is in cooperation with a displaying unit to display digital television program information. The device includes: a processing unit for receiving a digital television data signal comprising a plurality of program information, and generating a program schedule menu operable to display a portion of programs and the program information thereof according to the digital television data signal; an action analyzing scheduling unit for obtaining extraction parameters of peripheral programs of the portion of programs according to a position information of the portion of the programs from the processing unit; a program information analyzing unit for transforming the extraction parameters of the peripheral programs into an acceptable parameter form of the processing unit and then sending to the processing unit, so that the processing unit extracts the program information of the peripheral programs from the digital television information signal according to the parameter form; a program information backup unit for temporarily storing the program information of the peripheral program; and a program information accessing unit. When the program schedule menu is operated to scroll toward a peripheral direction of the displayed portion of programs, the program information accessing unit can read the program information of the peripheral programs corresponding to the peripheral direction within the program information backup unit and represents in the program schedule menu.

However, since the above fast displaying device of the digital television program schedule can only play the signals sent from a servo terminal, a rear end user cannot increase the information by his will for the subsequent play. For example, if the rear end users in the same community wish to announce certain information to all inhabitants in this community, this may not be achieved by representing on television, and thus it is necessary to use a traditional or Internet bulletin to announce this information. However, if the inhabitants are not familiar with the Internet or do not notice the traditional bulletin, they cannot get the announced information in the community. Therefore, if the television that is easy to operate currently can represent the information announced in the community, it is convenient for the inhabitants of the community to read the announced information.

### SUMMARY OF THE INVENTION

The object of the present invention is to represent information announced in the community on an easily operable television, so that the inhabitants of the community can read the announced information very conveniently.

In order to achieve the above object, the present invention provides a data playing system for a video platform, which includes: a rear end information generating unit having an operating interface to provide, edit and generate an announced data; a signal frequency-dividing unit for extracting at least one video signal containing video data therein and the announced data of the rear end information generating unit, and for loading the announced data of the rear end information generating unit into the video signal; and a user end outputting unit for extracting and playing the video signal to represent the announced data of the rear end information generating unit and the video data.

In addition, the present invention further provides a data playing method for a video platform, which includes: a data extracting step for extracting an announced data; an incorporating and extracting step for extracting at least one video signal and the announced data; a loading step for loading the announced data into the video signal; a playing step for playing the video signal via an outputting unit to represent the announced data and the video data.

### BRIEF DESCRIPTION OF THE DRAWINGS

FIG. 1 is a schematic view showing the construction of a preferred embodiment of the present invention; and

FIG. 2 is a flow chart of another preferred embodiment of the present invention.

### DETAILED DESCRIPTION OF THE INVENTION

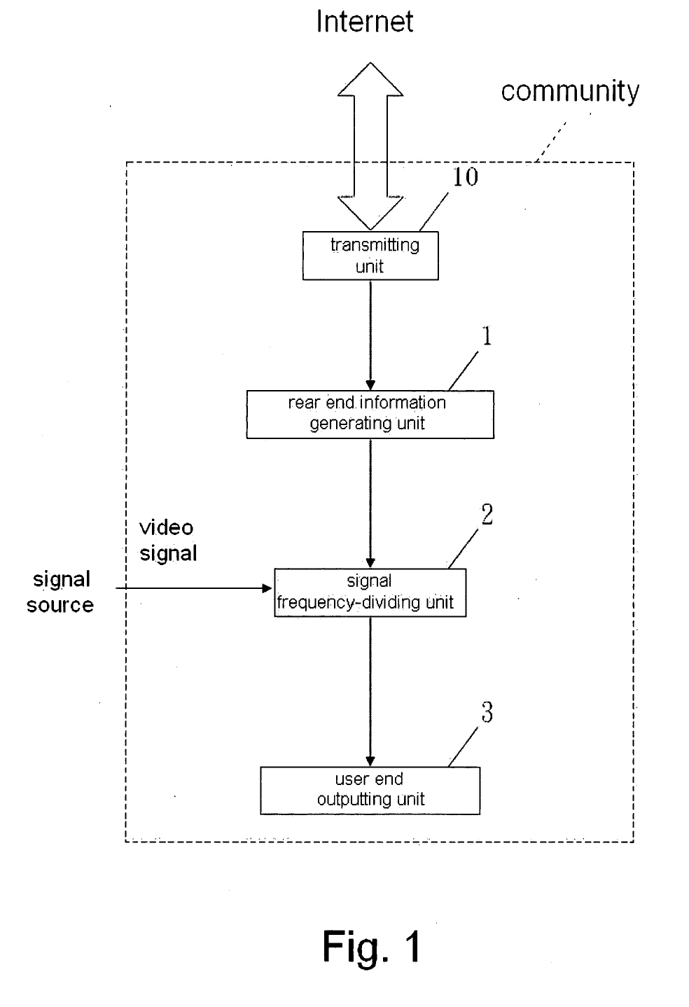

With reference to FIG. 1, it is a schematic view showing the construction of a preferred embodiment of the present invention. The present invention provides a data playing system for a video platform, which includes the following components.

A rear end information generating unit 1 has an operating interface for providing, editing and generating an announced data. The rear end information generating unit 1 is connected to a transmitting unit 10. The transmitting unit 10 allows a user to utilize Internet, thereby providing the data to be processed.

A signal frequency-dividing unit 2 extracts at least one video signal containing video information therein (i.e. a plurality of television program information) and the announced data of the rear end information generating unit 1, and loads the announced data of the rear end information generating unit 1 into the video signal.

A user end outputting unit 3 extracts and plays the video signal to represent the announced data of the rear end information generating unit 1 and the video data. The user end outputting unit 3 can be a television.

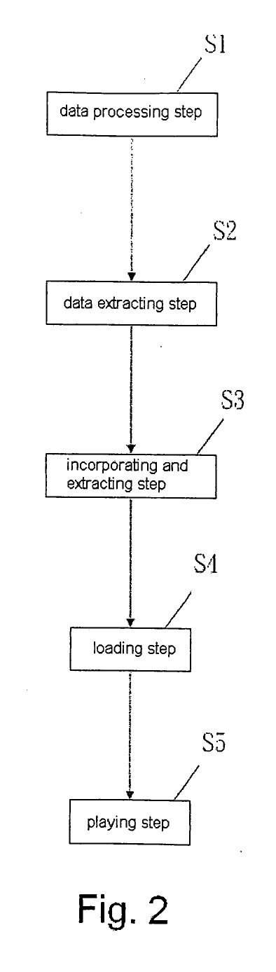

With reference to FIG. 2, it is a flow chart of another preferred embodiment of the present invention. Further, the present invention provides a data playing method for a video platform, which includes the following steps.

A data generating step S1 for providing, editing and generating an announced data is provided. The data generating step S1 can generate the announced data via the Internet.

A data extracting step S2 for extracting the announced data is provided. The data extracting step S2 can extract the announced data via the Internet.

An incorporating and extracting step S3 for extracting at least one video signal containing video data therein (i.e. the plurality of television program information) and the announced data.

A loading step S4 for loading the announced data into the video signal is provided.

A playing step S5 for playing the video signal via an outputting unit is provided, thereby representing the announced data and the video data.

According to the above, since the present invention utilizes a rear end information generating unit 1 to allow a rear end user to increase signals by his will so as to be played on a easily operable television, the inhabitants of the same community can get the announced information very easily without the Internet or traditional bulletin. Therefore, the present invention really has novelty and inventive steps and thus conforms to the requirements for an invention patent.

Although the present invention has been described with reference to the foregoing preferred embodiments, it will be understood that the invention is not limited to the details thereof. Various equivalent variations and modifications can still occur to those skilled in this art in view of the teachings of the present invention. Thus, all such variations and equivalent modifications are also embraced within the scope of the invention as defined in the appended claims.

What is claimed is:

1. A data playing system for a video platform, comprising:
a rear end information generating unit having an operating interface to provide, edit and generate an announced data;
a signal frequency-dividing unit for extracting at least one video signal containing video data therein and the announced data of the rear end information generating unit, and for loading the announced data of the rear end information generating unit into the video signal; and
a user end outputting unit for extracting and playing the video signal to represent the announced data of the rear end information generating unit and the video data.

2. The data playing system for a video platform according to claim 1, wherein the rear end information generating unit is connected to a transmitting unit, and the transmitting unit utilizes Internet to process the data.

3. The data playing system for a video platform according to claim 1, wherein the user end outputting unit is a television.

4. The data playing system for a video platform according to claim 1, wherein the video data contained in the video signal is a plurality of television program information.

5. A data playing method for a video platform, comprising:
a data extracting step for extracting an announced data;
an incorporating and extracting step for extracting at least one video signal and the announced data;
a loading step for loading the announced data into the video signal;
a playing step for playing the video signal via an outputting unit to represent the announced data and the video data.

6. The data playing method for a video platform according to claim 5, wherein the announced data is a plurality of television program information.

7. The data playing method for a video platform according to claim 5, wherein a data generating step is provided prior to the data extracting step, the data generating step is used to provide, edit and generate the announced data.

8. The data playing method for a video platform according to claim 5, wherein the data extracting step extracts the announced data via the Internet.
